(19) United States
(12) Patent Application Publication
(10) Pub. No.: US 2026/0187262 A1
(43) Pub. Date: Jul. 2, 2026

(54) PROTECTION OF CUSTOM DATA AND SOFTWARE DURING TRANSIT

(71) Applicant: Dell Products L.P., Round Rock, TX (US)

(72) Inventors: Srikanth Krishnamurthy SETHURAMACHAR, Bangalore (IN); Ajay SHENOY, Bangalore (IN); Kalyani KORUBILLI, Bangalore (IN); Sidharth RATH, Bangalore (IN)

(73) Assignee: Dell Products L.P., Round Rock, TX (US)

(21) Appl. No.: 19/002,523

(22) Filed: Dec. 26, 2024

(51) Int. Cl. G06F 21/62; G06F 21/31

(52) U.S. Cl. CPC G06F 21/6209; G06F 21/31

(57) ABSTRACT

An information handling system may include a physical storage resource with a software component stored thereon. Prior to delivery, the information handling system may be configured to secure access to the software component by: generating a key blob based on seed data; encrypting the software component using the key blob as an encryption key; and storing an encrypted version of the seed data in a certificate. After delivery, the information handling system may be configured to provide access to the software component by: verifying a credential of a user; in response to successful verification, providing the user with access to a validation procedure that is configured to decrypt the seed data from the certificate; re-generating the key blob based on the decrypted seed data; and decrypting the software component using the re-generated key blob as a decryption key.

### TECHNICAL FIELD

The present disclosure relates in general to information handling systems, and more particularly to supply chain protection of information handling system components.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A maker of information handling systems may install various pieces of custom software on a new system during its production at the factory (e.g., a custom operating system (OS), diagnostic software, support assistance software, and any other custom software, tools, and/or data). There is a need to protect such custom-installed software during the period before delivery to the customer, to ensure that nothing is altered during transit. Thus, the hard drives or other storage devices containing these components should be protected from any tampering during transit. Further, once the system reaches the customer site, the protected components should be easily accessible to the customer without any cumbersome further action from the customer.

An existing supply chain technology known as secured component verification (SCV) is sometimes used to ensure that the hardware components delivered to a customer match the factory-manufactured components. SCV helps a customer detect if any changes were made to the system's physical components during transit. Embodiments of this disclosure may operate by extending the SCV feature to include a drive locking key bundle so that the data on any storage media is encrypted during transit and can be decrypted only by the correct recipient of the server.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with supply chain data security may be reduced or eliminated.

In accordance with embodiments of the present disclosure, an information handling system may include a physical storage resource with a software component stored thereon. Prior to delivery, the information handling system may be configured to secure access to the software component by: generating a key blob based on seed data; encrypting the software component using the key blob as an encryption key; and storing an encrypted version of the seed data in a certificate. After delivery, the information handling system may be configured to provide access to the software component by: verifying a credential of a user; in response to successful verification, providing the user with access to a validation procedure that is configured to decrypt the seed data from the certificate; re-generating the key blob based on the decrypted seed data; and decrypting the software component using the re-generated key blob as a decryption key.

In accordance with these and other embodiments of the present disclosure, a method may include prior to delivery to a destination site, an information handling system that includes a physical storage resource having at least one software component stored thereon securing access to the at least one software component by: generating a key blob based on seed data; encrypting the at least one software component using the key blob as an encryption key; and storing an encrypted version of the seed data in a certificate; and after delivery to the destination site, the information handling system providing access to the at least one software component by: verifying a credential of a user; in response to successful verification, providing the user with access to a validation procedure that is configured to decrypt the seed data from the certificate; re-generating the key blob based on the decrypted seed data; and decrypting the at least one software component using the re-generated key blob as a decryption key.

In accordance with these and other embodiments of the present disclosure, an article of manufacture may include a non-transitory, computer-readable medium having computer-executable instructions thereon that are executable by an information handling system that includes a physical storage resource having at least one software component stored thereon for: prior to delivery to a destination site, securing access to the at least one software component by: generating a key blob based on seed data; encrypting the at least one software component using the key blob as an encryption key; and storing an encrypted version of the seed data in a certificate; and after delivery to the destination site, providing access to the at least one software component by: verifying a credential of a user; in response to successful verification, providing the user with access to a validation procedure that is configured to decrypt the seed data from the certificate; re-generating the key blob based on the decrypted seed data; and decrypting the at least one software component using the re-generated key blob as a decryption key.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of another example information handling system in the factory environment, in accordance with embodiments of the present disclosure; and

FIG. 3 illustrates a block diagram of another example information handling system in the customer environment, in accordance with embodiments of the present disclosure.

### DETAILED DESCRIPTION

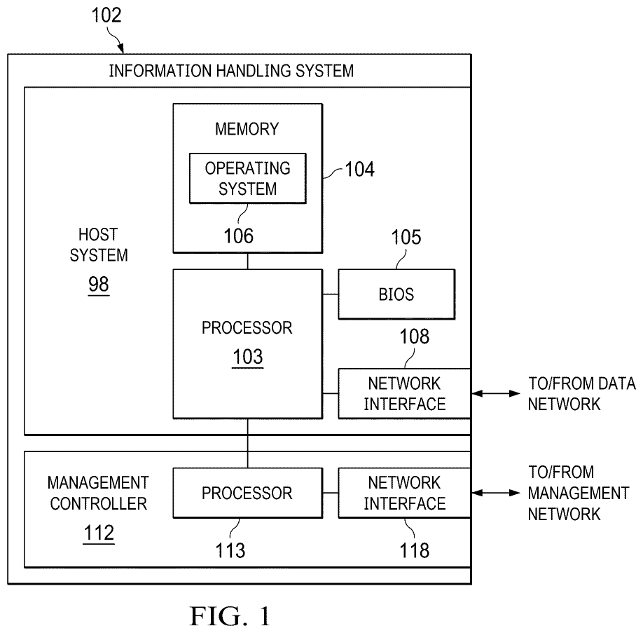

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may operate to protect customized software components of an information handling system such as information handling system 102 during the time between its factory provisioning and the delivery of the system to the customer site.

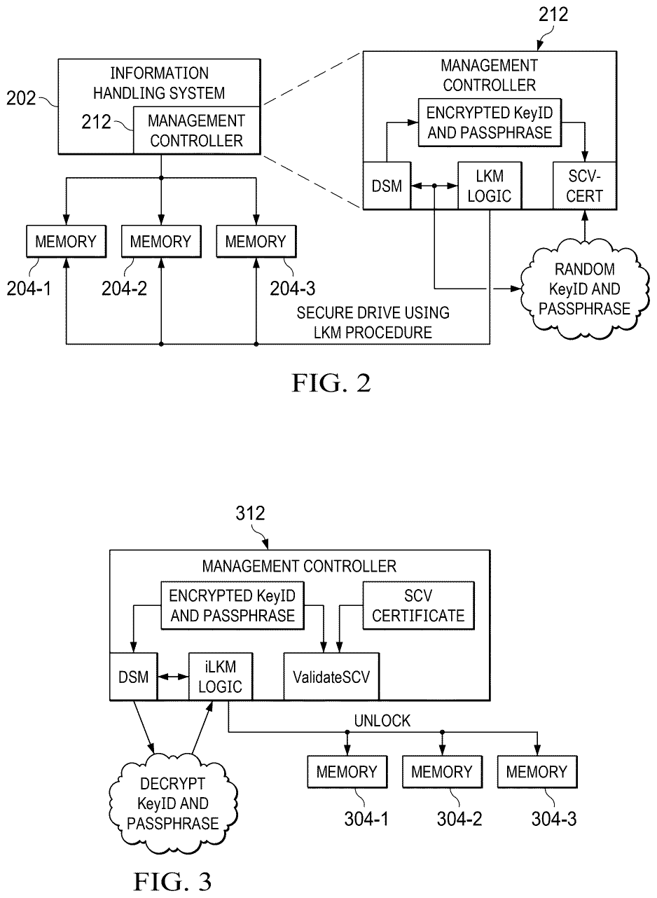

FIG. 2 illustrates selected components of another information handling system 202 during its production at the factory. A drive security manager (DSM) may operate as an internal module of management controller 212, unable to communicate with components outside of management controller 212. The DSM may secure one or more storage drives of information handling system 202 (e.g., at least including memories 204, which contain custom software components). This may be done by using a local key management (LKM) security mechanism such as iDRAC LKM (iLKM), which will be understood by one of ordinary skill in the art with the benefit of this disclosure. For the sake of concreteness, the following discussion will assume that memories 204 are self-encrypting drives (SEDs). In other implementations, different types of storage media may also be used.

At a high level, LKM may operate as follows. To secure a SED, a data element known as a key blob may be used (e.g., used a symmetric encryption key). To generate a key blob in a cryptographically secure manner, seeding elements including a key identifier (KeyId) and a passphrase may be used. The DSM may generate the KeyID and passphrase randomly or pseudorandomly in some implementations, and the LKM module of management controller 212 may then generate the key blob based on them.

Once a SED has been powered off, it is automatically locked. Thus upon power-on, a SED first needs to be unlocked using the LKM security procedure before any read or write operation can be performed. This feature of a SED internally protects the custom data inside it from any danger of tampering or corruption during transit.

Once the key blob has been generated based on the KeyID and passphrase, the DSM may utilize the core LKM module logic to secure the SEDs with the key blob. The key blob may in some implementations be re-generated each time it is needed by using the same KeyId and passphrase. Thus, there is no need for the system to cache the key blob in management controller 212.

In some cases, a secure enterprise key manager (SEKM) license may be required to enable LKM functionality on a management controller. Because this license may not always be present (e.g., due to product differentiation or licensing considerations), a special DSM module may be implemented to operate even without the presence of a SEKM license. For example, this special DSM may be limited to operate on only the drives identified at the factory and flagged as including custom software.

The DSM may also encrypt the KeyId and passphrase used for generating the LKM key blob and create a key bundle. The encrypted key bundle may then be embedded within an SCV certificate.

For example, when performing the final validation and verification procedures, the factory may create an SCV certificate for the information handling system as part of its existing SCV process. This existing process may be augmented to store the key bundle including the encrypted KeyID and passphrase. The information handling system may then be shipped to the customer site.

Turning now to FIG. 3, an example of a procedure using management controller 312 and taking place at the customer site is shown. The SCV application may be configured to operate in different modes (e.g., an administrator mode and a shipping mode). In the shipping mode, access to the procedures for decrypting memories 304 is unavailable. Only a customer with the correct license privilege can unlock the administrator mode and perform validation (e.g., by running a command such as ValidateSCV on management controller 312).

The supply chain security provided by this model may be based on the fact that this validation operation requires an SCV license, and so it cannot be performed during transit by some unprivileged user. For example, once the system has been deployed and set up at the customer site, management controller 312 may verify the customer's credentials online before allowing the use of administrator mode in the DSM.

When the customer has received the information handling system and wants to unlock the drives, the ValidateSCV operation on management controller 312 may extract the encrypted key bundle from the SCV certificate and supply it to the DSM. The DSM may decrypt the key bundle and provide the KeyId and passphrase to the LKM module of management controller 212. The DSM may use the LKM capabilities included in management controller 312 to unlock the locked drive by generating the LKM key blob dynamically using the supplied KeyId and passphrase. The user may then access the custom data on the drives, confident that it has not been tampered with since it left the factory. The user may also be given the option to change the KeyId and passphrase.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a physical storage resource having at least one software component stored thereon;
wherein, prior to delivery to a destination site, the information handling system is configured to secure access to the at least one software component by:
generating a key blob based on seed data;
encrypting the at least one software component using the key blob as an encryption key; and
storing an encrypted version of the seed data in a certificate; and
wherein, after delivery to the destination site, the information handling system is configured to provide access to the at least one software component by:
verifying a credential of a user;
in response to successful verification, providing the user with access to a validation procedure that is configured to decrypt the seed data from the certificate;
re-generating the key blob based on the decrypted seed data; and
decrypting the at least one software component using the re-generated key blob as a decryption key.

2. The information handling system of claim 1, wherein the physical storage resource is a self-encrypting drive.

3. The information handling system of claim 1, wherein the securing access to the at least one software component is carried out by a management controller of the information handling system.

4. The information handling system of claim 1, wherein the seed data includes a KeyID and a passphrase.

5. The information handling system of claim 1, wherein encrypting the at least one software component comprises encrypting the physical storage resource.

6. The information handling system of claim 1, wherein encrypting the at least one software component comprises using a local key management (LKM) component to encrypt the at least one software component.

7. A method comprising:
prior to delivery to a destination site, an information handling system that includes a physical storage resource having at least one software component stored thereon securing access to the at least one software component by:
generating a key blob based on seed data;
encrypting the at least one software component using the key blob as an encryption key; and
storing an encrypted version of the seed data in a certificate; and
after delivery to the destination site, the information handling system providing access to the at least one software component by:
verifying a credential of a user;
in response to successful verification, providing the user with access to a validation procedure that is configured to decrypt the seed data from the certificate;
re-generating the key blob based on the decrypted seed data; and
decrypting the at least one software component using the re-generated key blob as a decryption key.

8. The method of claim 7, wherein the physical storage resource is a self-encrypting drive.

9. The method of claim 7, wherein the securing access to the at least one software component is carried out by a management controller of the information handling system.

10. The method of claim 7, wherein the seed data includes a KeyID and a passphrase.

11. The method of claim 7, wherein encrypting the at least one software component comprises encrypting the physical storage resource.

12. The method of claim 7, wherein encrypting the at least one software component comprises using a local key management (LKM) component to encrypt the at least one software component.

13. An article of manufacture comprising a non-transitory, computer-readable medium having computer-executable instructions thereon that are executable by an information handling system that includes a physical storage resource having at least one software component stored thereon for:
prior to delivery to a destination site, securing access to the at least one software component by:
generating a key blob based on seed data;
encrypting the at least one software component using the key blob as an encryption key; and
storing an encrypted version of the seed data in a certificate; and
after delivery to the destination site, providing access to the at least one software component by:
verifying a credential of a user;
in response to successful verification, providing the user with access to a validation procedure that is configured to decrypt the seed data from the certificate;
re-generating the key blob based on the decrypted seed data; and
decrypting the at least one software component using the re-generated key blob as a decryption key.

14. The article of manufacture of claim 13, wherein the physical storage resource is a self-encrypting drive.

15. The article of manufacture of claim 13, wherein the securing access to the at least one software component is carried out by a management controller of the information handling system.

16. The article of manufacture of claim 13, wherein the seed data includes a KeyID and a passphrase.

17. The article of manufacture of claim 13, wherein encrypting the at least one software component comprises encrypting the physical storage resource.

18. The article of manufacture of claim 13, wherein encrypting the at least one software component comprises using a local key management (LKM) component to encrypt the at least one software component.
